(19) United States
(12) Patent Application Publication
(10) Pub. No.: US 2015/0306834 A1
(43) Pub. Date: Oct. 29, 2015

(54) HYDRAULIC AND ELECTRICAL CABLE STAND

(71) Applicants: Anthony L. Reaves, Pearland, TX (US); Tom Leervig, Houston, TX (US)

(72) Inventors: Anthony L. Reaves, Pearland, TX (US); Tom Leervig, Houston, TX (US)

(21) Appl. No.: 14/657,788

(22) Filed: Mar. 13, 2015

Related U.S. Application Data
(60) Provisional application No. 61/952,512, filed on Mar. 13, 2014.

(51) Int. Cl. B30B 15/00; F16L 3/10; F16L 3/22; F16M 11/04

(52) U.S. Cl. CPC B30B 15/0052; F16M 11/04; F16L 3/1091; F16L 3/221

(57) ABSTRACT

This hydraulic and electrical cable stand relates to a structure designed to preserve the integrity of hydraulic and electrical cables installed on trash compactors used for industrial purposes; more specifically, a stand which prevents the hydraulic and electrical cables from being damaged when the compactor is loaded for removal or emptying.

This stand relates to a structure designed to preserve the integrity of hydraulic and electrical cables installed on trash compactors used for industrial purposes; more specifically, a stand which prevents the hydraulic and electrical cables from being damaged when the compactor is loaded for removal or emptying. This application claims priority to U.S. Provisional Application No. 61/952,512 filed on Mar. 13, 2014.

### BACKGROUND OF INVENTION

Modern trash compactors are used by food retailers, department stores and other types of retail outlets. Since these receptacles are often filled with debris, removal is required by special hauling trucks that load the end of the receptacle onto the truck. Since most compactors have hydraulic and electrical connection these conductors must be taken off the receptacle prior to the removal of the load. Too often, the conductors are allowed to fall by the side of the receptacle and are damaged by the truck or compactor as it is pulled over the cable. The proposed stand avoids allowing the conductors to drop to the ground and permits them to be placed off the ground when not connected to the inlets on the compactor.

### SUMMARY OF INVENTION

A stand for accommodating hydraulic hoses and electrical cables to be connected to a compactor comprising a base affixed to the ground adjacent a compactor, a tee atop of the stand for clamping engagement of a plurality of hydraulic hoses and electrical cables, and an intermediate docking shelf for holding the hoses and cables off the ground and away from crushing or damaging engagement during the movement of the compactor.

### BRIEF DESCRIPTION OF A DRAWING

FIG. 1 is a side line drawing of the stand.

FIG. 2 is a photograph of the stand showing the engagement of the hoses and cables off the ground below the stand.

### DETAILED DESCRIPTION OF THE INVENTION

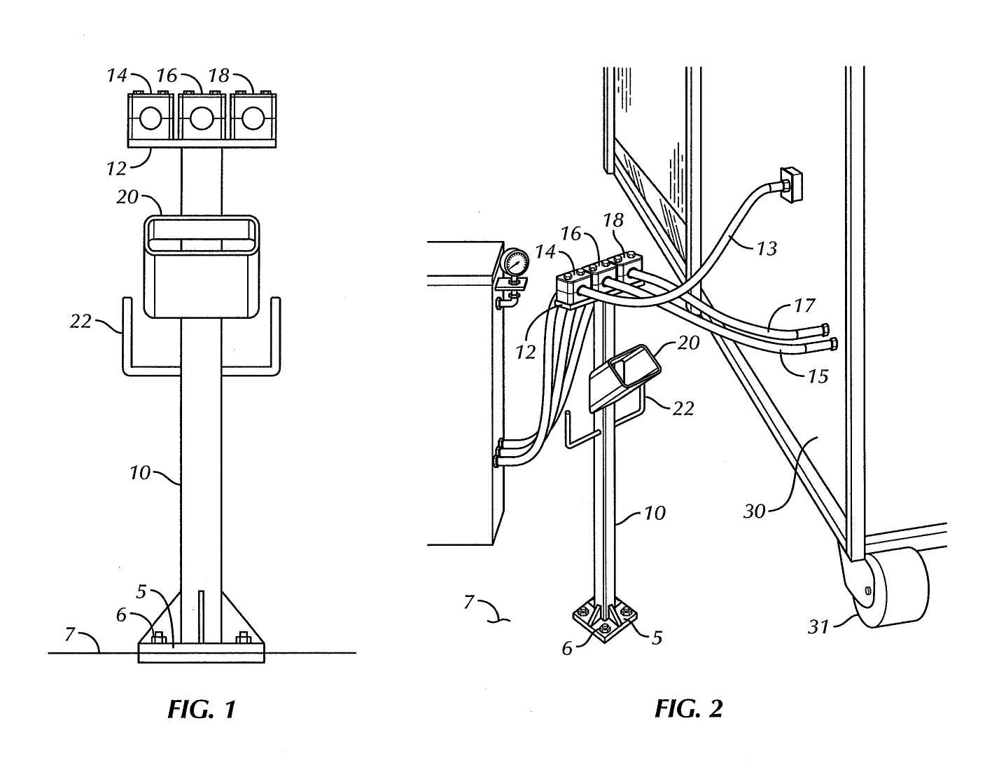

FIG. 1 is a line drawing of one embodiment of the invention showing the base 5 which is bolted 6 to the ground 7, a central support column 10 which is fabricated from square tubing in this embodiment but could be fabricated using steel piping. The T 12 atop the stand supports three hydraulic clamps 14, 16, 18 that can accommodate one electrical cable and two hydraulic conduits. Additional cables or conduits can be attached by extending the length of the T 12 across the top.

Intermediate the top of the stand and the base is an open-ended rack 20 into which the disconnected hydraulic lines and electrical can be stored. Longer hydraulic or electrical lines can be spooled around the L-shaped extensions 22 on either side of the support tubing 10.

The photograph of FIG. 2 shows the stand 10 in use next to a trash compactor 30. Each of the three lines 15, 17, 19 is supported in the topmost T-bracket 12 holding them off the ground and out of the way of users of the compactor 30 and the compactor wheels 31. The connector ends of each flexible member 15, 17, 19 supported by the T-bracket 12 provides a metal connector that can be easily bent or damaged if allowed to fall to the ground during movement of the trash compactor 30.

If additional connections are required, the top T-bracket 12 can be extended and the intermediate rack 20 can be enlarged to accept any number of connections to the compactor.

1. A stand comprising for accommodating hydraulic hoses and electrical cables to be connected to a compactor comprising:
a base affixed to the ground adjacent a compactor;
a tee atop of the stand for clamping engagement of a plurality of hydraulic hoses and electrical cables; and
an intermediate docking shelf for holding the plurality of hoses and cables off the ground and away from crushing or damaging engagement during the movement of the compactor.

2. A method of connecting a plurality of hydraulic and electrical cables to a trash compactor comprising the steps of:
attaching a fixable base to a flat area of ground adjacent a trash compactor;
installing a plurality of flexible connections through a series of clamps to retain the plurality of flexible connections from contacting the surface of the adjacent ground; and,
attaching the plurality of flexible connections to an appropriate connection site on the trash compactor to enable the compactor to be energized with hydraulic and electric power.
